(19) United States
(12) Patent Application Publication
(10) Pub. No.: US 2005/0200759 A1
(43) Pub. Date: Sep. 15, 2005

(54) Digital broadcasting system

(75) Inventor: Satoshi Hasegawa, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 11/073,651

(22) Filed: Mar. 8, 2005

(30) Foreign Application Priority Data
Mar. 9, 2004 (JP) 2004-066389

(51) Int. Cl. H04N 5/445

(52) U.S. Cl. 348/564

(57) ABSTRACT

A digital broadcasting system includes a broadcasting terminal and a receiver. The broadcasting terminal is connected with a network, and broadcasts transmission data which contains video data for television broadcasting, outline data indicating a specific area of the video data and attribution data relating to the specific area. The receiver is connected with the network and has a display unit. The receiver includes a storage unit; and a control unit configured to receive the transmission data from the broadcasting terminal, and to store the video data, the outline data and the attribution data of the transmission data in the storage unit. The control unit includes a video display control section and an attribution display control section. The video display control unit displays the video data and the outline data stored in the storage unit on the display unit in response to a reproduction instruction from a user, and the attribution display control unit reads out the attribution data corresponding to the outline data from the storage unit in response to an outline instruction from the user, and to display the attribution data on the display unit such that the attribution data is overlaid on the video data.

### BACKGROUND OF THE INVENTION

1. Field of the Invention

The present invention relates to a digital broadcasting system for carrying out digital broadcast.

2. Description of the Related Art

In digital broadcasting, data broadcasting as a multimedia service is available. The data broadcasting includes additional data broadcasting for complementing television broadcasting or voice broadcasting, and independent data broadcasting independent from the television broadcasting and the voice broadcasting, as described in “Data Hoso Gizyustu Dokuhon (Data Broadcasting Technical Readings)” (Ohmsha Ltd., Feb. 25, 2002, pp. 9-11) by Nobuyuki Yagi, Toshiro Yoshimura, an Kenji Kato.

In the independent data broadcasting, a user can view an image of the data broadcast by switching channels. As shown in FIG. 1, when the user switches channels, only an image of the data broadcast 101 is displayed on a display unit 100.

In the additional data broadcasting, the user can view an image of the data broadcast by a user depressing a d button (referred to as “data button”) on a remote controller while viewing the television broadcast or hearing the voice broadcast. A method for displaying the image of the additional data broadcast on the display unit includes L combining and overlay.

As shown in FIG. 2, the L combining is to display a screen for a data broadcast 103 constituted into an L shape on a display unit 100 and to display a reduced screen for a television broadcast 102 on a part of the screen displayed on the display unit 100 other than the screen for the data broadcast 103.

As shown in FIG. 3, the overlay is to display a screen for a television broadcast 104 on a display unit 100 and to display a screen for a data broadcast 105 on the display unit 100 while overlaying the screen for a data broadcast 105 on the screen for the television broadcast 104. In addition, by overlaying the screen for the data broadcast 105 on the screen for the television broadcast 104, titles or superimposed dialogs can be given.

Many television broadcasting companies carries out data broadcast of contents such as news, weather forecast, traffic data or sports result, independent from the television broadcast. In this case, a user can acquire certain data (news, weather forecast, traffic data or sports result) from the data broadcast.

### SUMMARY OF THE INVENTION

An object of the present invention is to provide a digital broadcasting system capable of ensuring improved usability.

Another object of the present invention is to provide a digital broadcasting system capable of acquiring data requested by a user from television broadcast.

Still another object of the present invention if to provide a digital broadcasting system capable of promptly providing data requested by a user.

It is yet another object of the present invention to provide a digital broadcasting system capable of promoting article distribution.

In an aspect of the present invention, a digital broadcasting system includes a broadcasting terminal and a receiver. The broadcasting terminal is connected with a network, and broadcasts transmission data which contains video data for television broadcasting, outline data indicating a specific area of the video data and attribution data relating to the specific area. The receiver is connected with the network and has a display unit. The receiver includes a storage unit; and a control unit configured to receive the transmission data from the broadcasting terminal, and to store the video data, the outline data and the attribution data of the transmission data in the storage unit. The control unit includes a video display control section and an attribution display control section. The video display control unit displays the video data and the outline data stored in the storage unit on the display unit in response to a reproduction instruction from a user, and the attribution display control unit reads out the attribution data corresponding to the outline data from the storage unit in response to an outline instruction from the user, and to display the attribution data on the display unit such that the attribution data is overlaid on the video data.

Here, the storage unit includes a first optical disc storage section as a first memory region, a second optical disc storage section as a second memory region, and a memory. The first optical disc storage section stores the video data and the outline data, and the second optical disc storage section stores the attribution data. The control unit may further include a read control section to read out the attribution data from the second optical disc storage section in response to a read instruction from the user to store in the memory. The video display control section displays the video data and the outline data stored in the first optical disc storage section on the display unit in response to the reproduction instruction after the read instruction, and the attribution display control section reads the attribution data corresponding to the outline data from the memory in response to the outline instruction, and display the attribution on the display unit such that the attribution data is overlaid on the video data. In this case, the control unit may further include a video storage control section, a first attribution storage control section, a reception control section, and a second attribution storage control section. The video storage control section stores the video data and the outline data in the first optical disc storage section when receiving the transmission data from the broadcasting terminal. The first attribution storage control section stores the attribution data in the memory when receiving the transmission data from the broadcasting terminal. The reception control section outputs an attribution storage permission instruction when not receiving the transmission data from the broadcasting terminal. The second attribution storage control section reads out the attribution data from the memory in response to the attribution storage permission instruction to store in the second optical disc storage section.

Also, the outline data may contain an attribution data identifier to identify the attribution data. The attribution display control section reads out the attribution data corresponding to the attribution data identifier from the memory in response to the outline instruction and displays on the display unit such that the attribution data is overlaid on the video data.

Also, the outline data may contain position data to specify a position of the specific area of the video data. The video display control section reads out the video data and the outline data stored in the storage unit in response to the reproduction instruction, displays the video data on the display unit, and displays the outline data in the specific area of the video data on the display unit based on the position data such that the outline data is overlaid on the video data.

In another aspect of the present invention, a receiver receives transmission data which contains video data for television broadcasting, outline data indicating a specific area of the video data and attribution data relating to the specific area. The receiver includes a storage unit; and a control unit configured to receive the transmission data, and to store the video data, the outline data and the attribution data of the transmission data in the storage unit. The control unit includes a video display control section and an attribution display control section. The video display control section displays the video data and the outline data stored in the storage unit on the display unit in response to a reproduction instruction from a user. The attribution display control section reads out the attribution data corresponding to the outline data from the storage unit in response to an outline instruction from the user, and displays the attribution data on the display unit such that the attribution data is overlaid on the video data.

Here, the storage unit may include a first optical disc storage section as a first memory region, a second optical disc storage section as a second memory region, and a memory. The first optical disc storage section stores the video data and the outline data, and the second optical disc storage section stores the attribution data. The control unit may further include a read control section configured to read out the attribution data from the second optical disc storage section in response to a read instruction from the user to store in the memory. The video display control section displays the video data and the outline data stored in the first optical disc storage section on the display unit in response to the reproduction instruction after the read instruction. The attribution display control section reads the attribution data corresponding to the outline data from the memory in response to the outline instruction, and displays the attribution on the display unit such that the attribution data is overlaid on the video data.

Also, the control unit may further include a video storage control section, a first attribution storage control section, a reception control section and a second attribution storage control section. The video storage control section stores the video data and the outline data in the first optical disc storage section when receiving the transmission data from the broadcasting terminal. The first attribution storage control section stores the attribution data in the memory when receiving the transmission data from the broadcasting terminal. The reception control section outputs an attribution storage permission instruction when not receiving the transmission data from the broadcasting terminal. The second attribution storage control section reads out the attribution data from the memory in response to the attribution storage permission instruction to store in the second optical disc storage section.

Also, the outline data may contain an attribution data identifier to identify the attribution data. The attribution display control section reads out the attribution data corresponding to the attribution data identifier from the memory in response to the outline instruction and displays on the display unit such that the attribution data is overlaid on the video data.

Also, the outline data may contain position data to specify a position of the specific area of the video data. The video display control section reads out the video data and the outline data stored in the storage unit in response to the reproduction instruction, displays the video data on the display unit, and displays the outline data in the specific area of the video data on the display unit based on the position data such that the outline data is overlaid on the video data.

Also, the attribution data may contain at least one of personal data relating to a person in the specific area of the video data and article data relating to an article in the specific area of the video data. Also, the attribution data may contain at least an URL of an attribution relating terminal relating to the person or a selling agency of the article. The control unit may further include an URL communication control section configured to communicate with the attribution relating terminal through the communication network by using the URL in response to an URL communication instruction from the user.

In another aspect, the present invention relates a computer-readable software product for realizing a method of allowing data relating to television broadcast to be utilized. The method is achieved by receiving transmission data which contains video data for the television broadcast, outline data indicating a specific area of the video data and attribution data relating to the specific area; by storing the video data, the outline data and the attribution data contained in the transmission data in a storage unit; by reading out the video data and the outline data from the storage unit in response to a reproduction instruction from a user to display on the display unit; and by reading out the attribution data corresponding to the outline data from the storage unit in response to an outline instruction from the user, to display the attribution data on the display unit such that the attribution data is overlaid on the video data.

Here, the storing may be achieved by storing the video data and the outline data in a first optical disc storage section of the storage unit; and by storing the attribution data in a second optical disc storage section of the storage unit. The reading out the video data and the outline data may be achieved by reading out the video data and the outline data from the first optical disc storage section to display on the display unit in response to the reproduction instruction. The reading out the attribution data may be achieved by reading out the attribution data from the second optical disc storage section in response to a read instruction from the user before the reproduction instruction to store in a memory of the storage unit, and reading out the attribution data from the memory in response to the outline instruction, to display the attribution on the display unit such that the attribution data is overlaid on the video data.

Also, the storing the attribution data may be achieved by storing the attribution data in the memory when receiving the transmission data; by setting an attribution storage permission flag when not receiving the transmission data; and by reading out the attribution data from the memory in response to the attribution storage permission flag to store in the second optical disc storage section.

Also, the outline data may contain an attribution data identifier to identify the attribution data. The reading out the attribution data may be achieved by reading out the attribution data corresponding to the attribution data identifier from the memory in response to the outline instruction to display on the display unit such that the attribution data is overlaid on the video data.

Also, the outline data may contain position data to specify a position of the specific area of the video data. The reading out the video data and the outline data may be achieved by reading out the video data and the outline data from the storage unit in response to the reproduction instruction, to display the video data on the display unit, and to display the outline data in the specific area of the video data on the display unit based on the position data such that the outline data is overlaid on the video data.

Also, the attribution data may contain at least one of personal data relating to a person in the specific area of the video data and article data relating to an article in the specific area of the video data. Also, the attribution data may contain at least an URL of an attribution relating terminal relating to the person or a selling agency of the article. In this case, the method may further include communicating with an attribution relating terminal relating to the person or selling agency through a communication network by using the URL in response to an URL communication instruction from the user.

In another aspect of the present invention, a method of allowing data relating to television broadcast to be utilized, may be achieved by broadcasting through a network, transmission data which contains video data for television broadcasting, outline data indicating a specific area of the video data and attribution data relating to the specific area; by receiving the transmission data; by storing the video data, the outline data and the attribution data contained in the transmission data in a storage unit; by reading out the video data and the outline data from the storage unit in response to a reproduction instruction from a user to display on the display unit; and by reading out the attribution data corresponding to the outline data from the storage unit in response to an outline instruction from the user, to display the attribution data on the display unit such that the attribution data is overlaid on the video data.

### BRIEF DESCRIPTION OF THE DRAWINGS

FIG. 1 is a diagram showing an example of independent data broadcast;

FIG. 2 is a diagram showing an example of additional data broadcast (by L combining);

FIG. 3 is a diagram showing an example of additional data broadcast by overlay;

FIG. 4 is a block diagram showing the configuration of a digital broadcasting system according to the present invention;

FIG. 5 is a block diagram showing the configuration of a broadcasting terminal in the digital broadcasting system according to the present invention;

FIG. 6 is a block diagram showing the configuration of a control unit of the broadcasting terminal in the digital broadcasting system according to the present invention;

FIG. 7 is a diagram showing video data and outline data in the digital broadcasting system according to the present invention;

FIG. 8 is a diagram showing the outline data in the digital broadcasting system according to the present invention;

FIG. 9 is a diagram showing attribution data in the digital broadcasting system according to the present invention;

FIG. 10 is a block diagram showing the receiver in the digital broadcasting system according to the present invention;

FIG. 11 is a diagram showing an optical disk as a storage unit of the receiver in the digital broadcasting system according to the present invention;

FIG. 12 is a block diagram showing a configuration of a control unit of the receiver in the digital broadcasting system according to the present invention;

FIG. 13 is a diagram showing a flag storage unit in the control unit of the receiver in the digital broadcasting system according to the present invention;

FIG. 14 shows video data, outline data, and attribution data displayed on a display unit in the digital broadcasting system according to the present invention;

FIG. 15 is a flowchart showing a transmission process as an operation of the broadcasting terminal of the digital broadcasting system according to the present invention;

FIG. 16 is a flowchart showing a reception process as an operation of the receiver of the digital broadcasting system according to the present invention;

FIG. 17 is a flowchart showing a video display process as an operation of the receiver of the digital broadcasting system according to the present invention; and

FIG. 18 is a flowchart showing an attribution display process as an operation of the receiver of the digital broadcasting system according to the present invention.

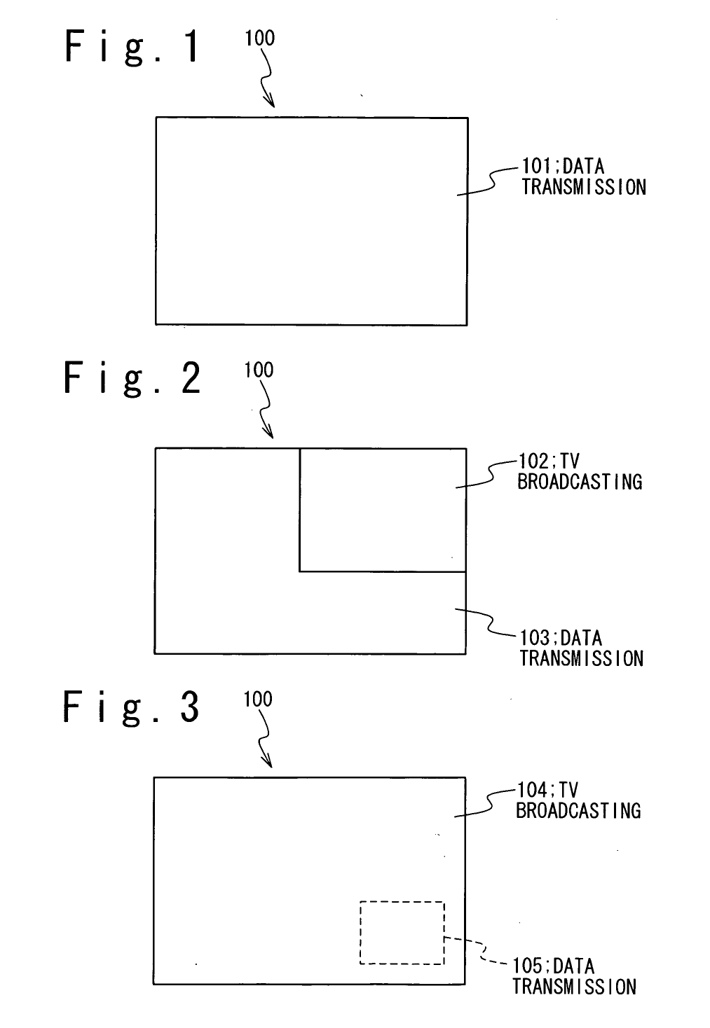

### DESCRIPTION OF THE PREFERRED EMBODIMENTS

Hereinafter, a digital broadcasting system according to the present invention will be described in detail with reference to the attached drawings.

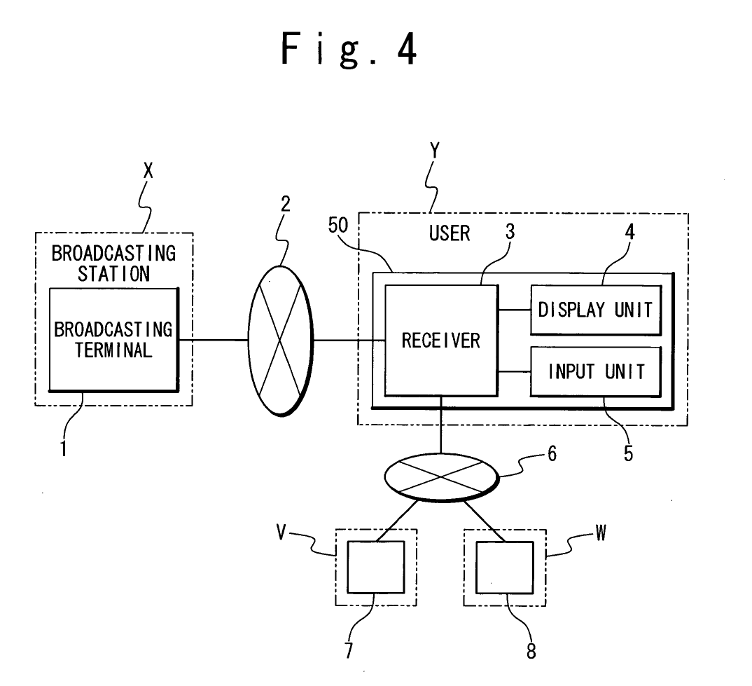

FIG. 4 is a block diagram showing the configuration of the digital broadcasting system according to the present invention. The digital broadcasting system according to the present invention includes a broadcasting terminal 1 and a television set 50. The broadcasting terminal 1 and the receiver 3 are connected to each other through a network 2. The broadcasting terminal 1 is connected to an input unit and a display unit which are not shown. The television set 50 includes a receiver 3, a display unit 4, and an input unit 5. The receiver 3 is connected to the display unit 4 and the input unit 5. The broadcasting terminal 1 is used by a television broadcasting company (broadcasting station) X. The television set 50 is used by a user Y. The input unit 5 includes a pointing device and a remote controller.

The receiver 3 is further connected to a communication network 6 for Internet connection. A user can utilize the Internet using the receiver 3. Terminals 7 and 8 are connected to the communication network 6. The terminal 7 is used by a user V and the terminal 8 is used by a user W. The receiver 3 is communicable with the terminal 7 using a Uniform Resource Locator (URL) of the terminal 7.

The broadcasting station X carries out data broadcast of news, weather forecast, traffic information or sports result, independently from television broadcast. Accordingly, hereinafter, data of the television broadcast to be displayed on a screen will be referred to as “video data” whereas data of the data broadcast will be referred to as “independent data”. The broadcasting terminal 1 transmits to the network 2 the video data for the television broadcast, voice data for voice broadcast, and the independent data for the data broadcast. The receiver 3 receives the video data, the voice data, and the independent data.

In the independent data broadcast, the user Y can view the independent data by operating the input unit 5 and switching channels. In additional data broadcast (by L combining or overlay), the user Y can view the independent data by operating the input unit 5 during viewing the video data and hearing the voice data, e.g., pushing a d button (data button). In this way, the user Y can acquire certain information such as news, weather forecast, traffic information or sports result independent of the television broadcast (video data).

The broadcasting terminal 1 transmits transmission data including video data, outline data, and attribution data when transmitting the video data. The outline data is data that represents a specific region of the video data and that is displayed on the display unit 4 in synchronism with the video data by the receiver 3. The attribution data is data that represents information on the specific region of the video data and that is displayed on the display unit 4 by the receiver 3 when the user Y designates the outline data displayed on the display unit 4. The outline data and the attribution data will be described later in detail.

The receiver 3 stores the video data, the outline data, and the attribution data in a storage unit, which would be described later, included in the receiver 3. When the user Y issues a reproduction instruction using the input unit 5, the receiver 3 displays the video data and outline data stored in the storage unit of the receiver 3 on the display unit 4 in response to the reproduction instruction while overlaying the outline data on the video data. When the user Y issues an outline instruction by using the input unit 5, the receiver 3 reads the attribution data corresponding to the outline data from the storage unit of the receiver 3 and displays the attribution data while overlaying the attribution data on the video data.

The user Y often wants to know of information on a person or an article displayed in the specific region of the video data in the television broadcast. In this case, the receiver 3 provides the user Y with attribution data on the specific region of the video data in response to the outline instruction from the user Y. As can be seen, according to the digital broadcasting system according to the present invention, the user Y can acquire attribution data requested by the user Y from the video data in the television broadcast. Thus, the digital broadcasting system according to the present invention can provide improved usability of the receiver 3 by allowing the user Y not only to view the video data in the television broadcast but also to issue a request when the user Y wants to know the attribution data.

The configuration of the broadcasting terminal 1 and the receiver 3 that realize such an advantage will next be described.

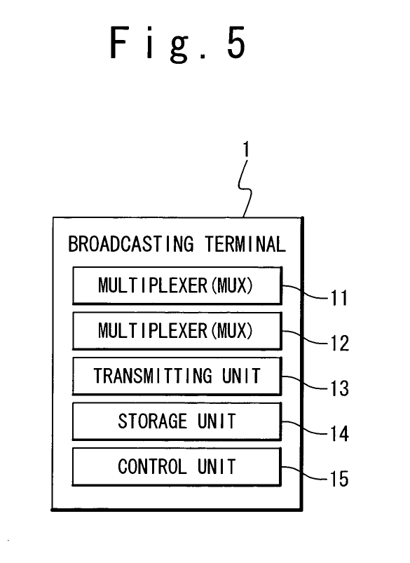

FIG. 5 is a block diagram showing the configuration of the broadcasting terminal 1 in the digital broadcasting system according to the present invention. The broadcasting terminal 1 includes multiplexers (MUXs) 11 and 12, a transmitting unit 13, a storage unit 14, and a control unit 15. The transmitting unit 13 is connected to the network 2. The storage unit 14 stores a plurality of video data. A data format of the video data is exemplified by MPEG 2 (Moving Picture Experts Group 2).

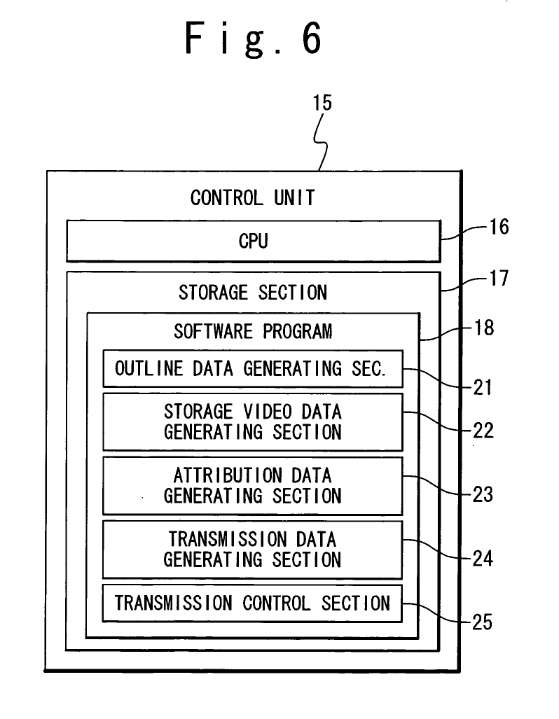

FIG. 6 is a block diagram showing the configuration of the control unit 15 of the broadcasting terminal 1 in the digital broadcasting system according to the present invention. The control unit 15 is a computer, and includes a central processing unit (CPU) 16 and a storage section 17. The storage section 17 stores a computer program 18 to be executed by the CPU 16. The computer program 18 includes an outline data generating section 21, a storage video data generating section 22, an attribution data generating section 23, a transmission data generating section 24, and a transmission control section 25.

The outline data generating section 21 in the control unit 15 of the broadcasting terminal 1 will first be described.

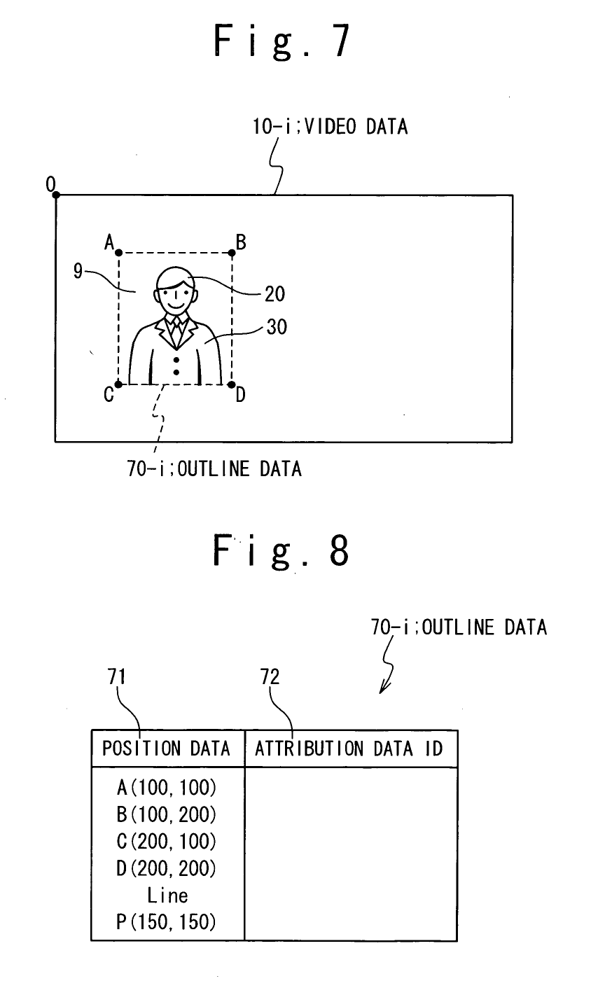

The outline data generating section 21 takes out video data 10-i (where i=1, 2, . . . , n) from video data 10-1 to 10-n (where n is an integer equal to or greater than 1) stored in the storage unit 14 by an operation of the input unit by an operator of the broadcasting station X. The outline data generating section 21 generates outline data 70-i shown in FIG. 7 by the operation of the input unit by the operator of the broadcasting station X. The outline data 70-i represents a specific region 9 of the video data 10-i, and a person 20 and an article 30 appear in the specific region 9. Alternatively, only the person 20 or only the article 30 may appear in the specific region 9. In this embodiment, it is assumed that the person 20 appearing in the specific region 9 wears the article 30. Examples of the article 30 which the person 20 wears include clothes such as a suit, a shirt, trousers, and a uniform and accessories such as a watch, a necklace, a bracelet, and a cap or a hat.

In order for the receiver 3 to display the outline data 70-i and the video data 10-i while overlaying the outline data 70-i on the video data 10-i, the broadcasting terminal 1 needs to determine a position of the specific region 9.

The outline data 70-i includes position data indicating the position of the specific region 9. The position data is represented by coordinates. As shown in FIG. 7, if the specific region 9 is rectangular, the outline data 70-i includes coordinate points A, B, C, and D relative to a coordinate point O. The coordinate point O is an origin which is a first scanned pixel among those constituting the video data 10-i. If a horizontal direction parallel to a scan line is denoted by x and a vertical direction perpendicular to the scan line is denoted by y, the coordinate point O (x, y) is denoted by (0, 0). The coordinate points A (x, y), B (x, y), C (x, y), and D (x, y) represent distances of the points A, B, C, and D from the coordinate point O (0, 0) on a screen.

As shown in FIG. 8, the outline data 70-i includes a position data field in which position data 71 is described and an attribution data identifier field in which an attribution data identifier 72 is described.

The outline data generating section 21 writes the coordinate point A, the coordinate point B, the coordinate point C, the coordinate point D, an instruction for drawing the shape of the specific region 9, and a central coordinate point in the position data field by the operator of the broadcasting station X. For example, the coordinate point A (x, y) is represented by (100, 100), the coordinate point B (x, y) is represented by (100, 200), the coordinate point C (x, y) is represented by (200, 100), the coordinate point D (x, y) is represented by (200, 200), and the central coordinate point (x, y) is represented by (150, 150). The central coordinate point (150, 150) represents an intersecting point between a diagonal that connects the coordinate points A and D and a diagonal that connects the coordinate points B and C. The instruction for drawing the shape of the specific region 9 is “Line”. The instruction “Line” and the central coordinate point are used by the receiver 3 to recognize the specific region 9. The receiver 3 connects the coordinate point A to the coordinate point B by a line, connects the coordinate point B to the coordinate point D by a line, connects the coordinate point D to the coordinate point C by a line, connects the coordinate point C to the coordinate point A by a line based on the coordinate point A, the coordinate point B, the coordinate point C, the coordinate point D, the instruction “Line” representing the shape of the specific region 9, and the central coordinate point. Thus, the receiver 3 can thereby recognize the specific region 9. When the receiver 3 displays the outline data 70-i, the line connecting the coordinate points A and B, the line connecting the coordinate points B and D, the line connecting the coordinate points D and C, and the line connecting the coordinate points C and A are displayed on the display unit 4. Examples of the lines displayed on the display unit 4 include a solid line, a dotted line, or a void line.

If the specific region 9 is designated as a circle, the outline data generating section 21 may write, as the position data 71, the instruction “Circle” for drawing the shape of the specific region 9, a radius (50) of the circle, and the central coordinate point (150, 150) in the position data field by the operation by the operator of the broadcasting station X.

The outline data generating section 21 writes the attribution data identifier 72 in the attribution data identifier field by the operator of the broadcasting station X.

The storage video data generating section 22 of the control unit 15 in the broadcasting terminal 1 will next be described. The storage video data generating section 22 controls the multiplexer MUX 11 in the broadcasting terminal 1 so as to multiplex the video data 10-i with the outline data 70-i through the operation by the operator of the broadcasting station X and to generate the storage video data.

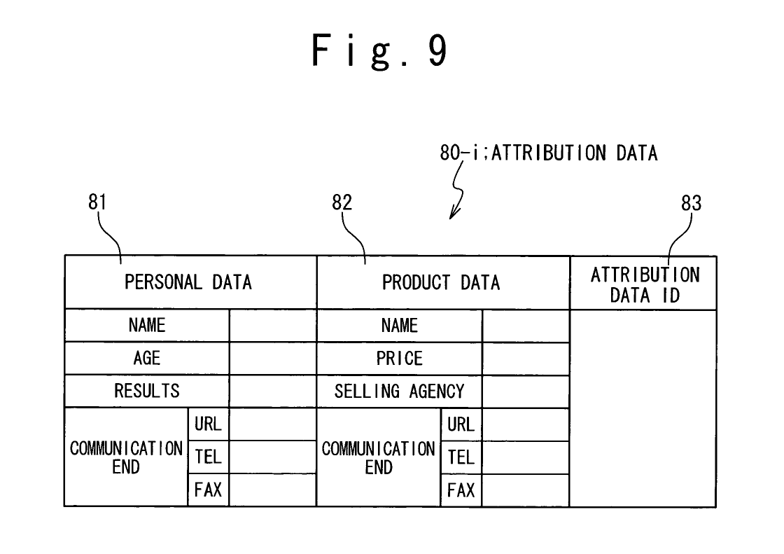

The attribution data generating section 23 of the control unit 15 in the broadcasting terminal 1 will be described. The attribution data generating section 23 generates attribution data 80-i relating to the specific region 9 of the video data 10-i through the operation by the operator of the broadcasting station X. As shown in FIG. 9, the attribution data 80-i includes a personal data field in which personal data 80 is described, an article data field in which article data 82 is described, and an attribution data identifier field in which an attribution data identifier 83 is described.

The personal data 81 is data on a person 20 appearing in the specific region 9 of the video data 10-i. The personal data 81 includes a name, an age, and a record of performance of the person 20. The record of performance of the person 20 includes a team to which the person 20 belongs, an annual salary, and a record if the person 20 is a sport player. If the person 20 is an actor or an actress, the record of performance of the person 20 includes an agency and a title of a monumental movie among movies the person 20 appears. The person 20 or a party concerned with the person 20 (team or agency) is the user V, who owns the terminal 7, a telephone, and a facsimile machine. The personal data 81 also includes cover address with the person 20. The cover address of the person 20 includes at least one of the URL of the terminal 7 owned by the person 20 or the party concerned with the person 20, a telephone number of the telephone owned by the person 20 or the party concerned with the person 20, and a facsimile number of the facsimile owned by the person 20 or the party concerned with the person 20. The broadcasting station X is tied up with the person 20 or the party concerned with the person 20. The attribution data generating section 23 writes, as the personal data 81, the name of the person 20, the age of the person 20, the record of performance of the person 20, and the cover address (the URL of the terminal 7, the telephone number, and the facsimile number) of the person 20 in the persona data field by the operator of the broadcasting station X.

The article data 82 is data on the article 30 appearing in the specific region 9 of the video data 10-i. The article data 82 includes a name, a price, and a selling agency of the article 30. The selling agency is the user W, who owns the terminal 8, a telephone, and a facsimile machine. The article data 82 also includes a cover address of the selling agency. The cover address includes at least one of a telephone number of the telephone owned by the selling agency, and a facsimile number of the facsimile owned by the selling agency. The broadcasting station X is tied up with selling agency. The attribution data generating section 23 writes, as the article data 82, the name of the article 30, the price of the article 30, a name of the selling agency, and the cover address (the URL of the terminal 8, the telephone number, and the facsimile number) of the selling agency in the article data field by the operator of the broadcasting station X.

The attribution data identifier 83 represents a name of the attribution data 80-i, and the name is equal to the name of the attribution data identifier 72. The attribution data generating section 23 writes the attribution data identifier 83 in the attribution data identifier field by the operator of the broadcasting station X.

The transmission data generating section 24 and the transmission control section 25 of the control unit 15 in the broadcasting terminal 1 will be described. The transmission data generating section 24 controls the MUX 12 in the broadcasting terminal 12 so as to multiplex the storage video data (video data 10-i and the outline data 70-i) with the attribution data 80-i through an operation of the input unit by the operator of the broadcasting station X, and to generate the transmission data.

The transmission control section 25 stores the transmission data {storage video data (video data 10-i and outline data 70-i) and attribution data 80-i} generated by the transmission data generating section 24 in the storage unit 14. The transmission control section 25 controls the transmitting unit 13 in the broadcasting terminal 1 so that first to n-th transmission data stored in the storage unit 14 are transmitted to the receiver 3 in an order.

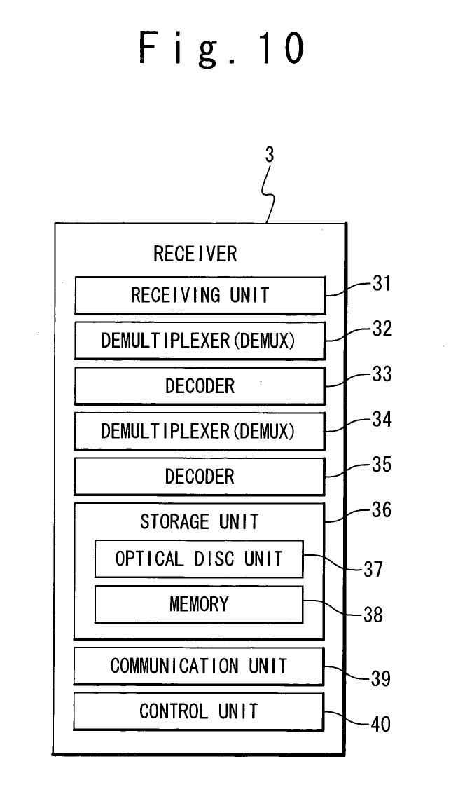

FIG. 10 shows a configuration of the receiver 3 in the digital broadcasting system according to the present invention. The receiver 3 includes a receiving unit 31, demultiplexers (DEMUXs) 32 and 34, decoders 33 and 35, a storage unit 36, a communication unit 39, and a control unit 40. The communication unit 39 is connected to the network 2, and receives the transmission data from the broadcasting terminal 1. The communication unit 39 is connected to the communication network 6. The storage unit 36 is a storage unit of the receiver 3. The storage unit 36 includes an optical disc unit 37 and a memory 38. The optical disc unit 37 is exemplified by a digital versatile disc (DVD). The reason for using the optical disc unit 37 and the memory 38 will be described later.

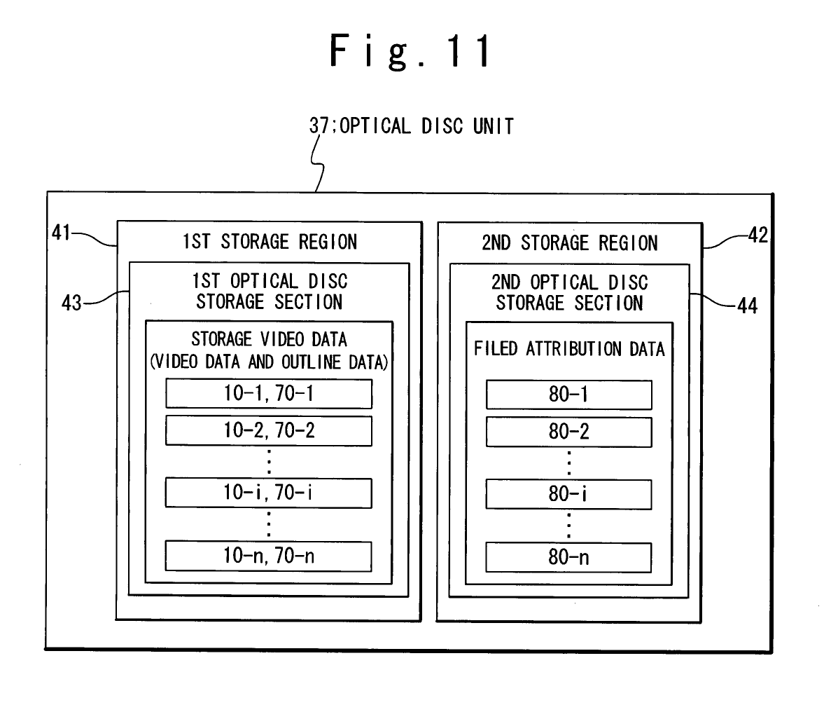

FIG. 11 shows the optical disc unit 37 that constitutes the storage unit 36 of the receiver 3 in the digital broadcasting system according to the present invention. The optical disc unit 37 includes a first optical disc storage section 43 that serves as a first storage region 41, and a second optical disc storage section 44 that serves as a second storage region 42.

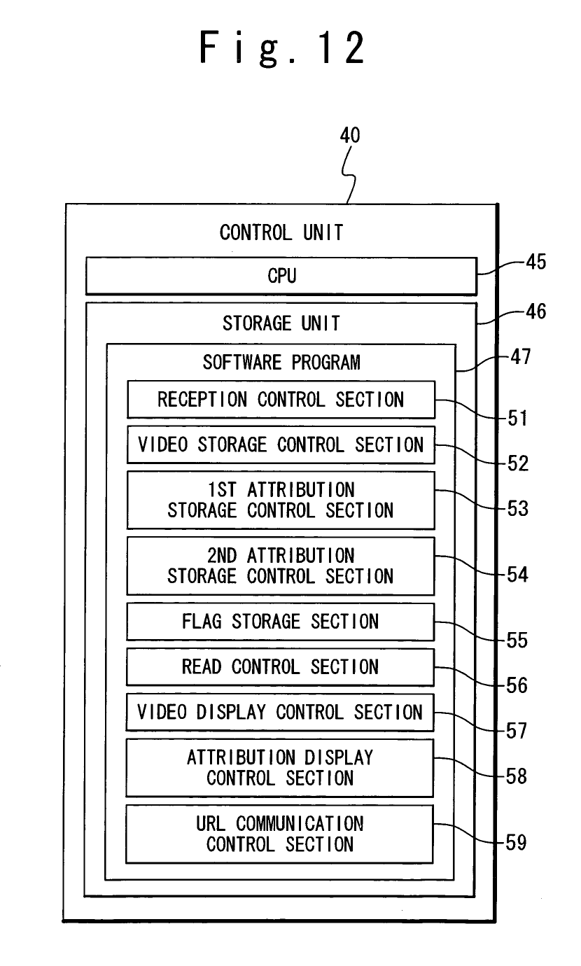

FIG. 12 shows the configuration of the control unit 40 of the receiver 3 in the digital broadcasting system according to the present invention. The control unit 40 is a computer, and includes a CPU 45 and a storage unit 46. The storage unit 46 stores a computer program 47 to be executed by the CPU 45. The computer program 47 includes a reception control section 51, a video storage control section 52, a first attribution storage control section 53, a second attribution storage control section 54, a flag storage section 55, a read control section 56, a video display control section 57, an attribution display control section 58, and a URL communication control section 59.

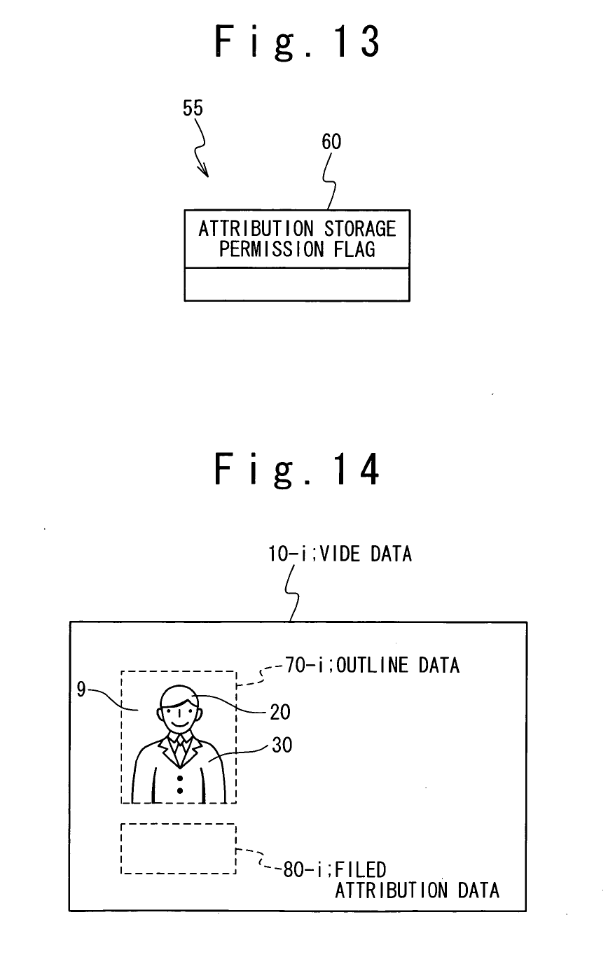

The reception control section 51 and the flag storage section 55 of the control unit 40 of the receiver 3 will be described. As shown in FIG. 13, an attribution storage permission indication flag 60 is set or stored by the flag storage section 55 by the reception control section 51. When the receiving unit 31 receives the transmission data, the reception control section 51 outputs a reception detection signal to the flag storage section 55. The flag storage section 55 resets the attribution storage permission indication flag 60 in response to the reception detection signal. When the receiving unit 31 does not receive the transmission data, the reception control section 51 outputs a reception non-detection signal in place to the reception detection signal to the flag storage section 55. The attribution storage permission flag 60 is set by the flag storage section 55 in response to the reception non-detection signal.

The video storage control section 52 of the control unit 40 in the receiver 3 will be described. The video storage control section 52 controls the DEMUX 32 of the receiver 3 to demultiplex the transmission data received by the receiving unit 31 of the receiver 3 into the storage video data (video data 10-i and outline data 70-i) and the attribution data 80-i. The video storage control section 52 controls the decoder 33 of the receiver 3 to decode the storage video data (video data 10-i and outline data 70-i) demultiplexed by the video storage control section 52 and to store the decoded data in the first optical disc storage section 43. If the attribution storage permission indication flag 60 is not set by the flag storage section 55, the video storage control section 52 notifies to the first optical disc storage section 43 that the storage video data (video data 10-i and outline data 70-i) is stored (recorded) in the fist optical disc storage section 43.

The first attribution storage control section 53 and the second attribution storage control section 54 of the control unit 40 in the receiver 3 will be described. The first attribution storage control section 53 converts the attribution data 80-i demultiplexed by the video storage control section 52 into a file. The attribution data 80-i converted into the file (attribution data-turned file 80-i) is converted into a form suited for a read operation by the read control section 56 and the attribution display control section 58 and suited for display of the data 80-i on the display unit 4. The first attribution storage control section 53 stores the attribution data-turned file 80-i in the memory 38.

If the attribution storage permission indication flag 60 is set in the flag storage section 55, the second attribution storage control section 54 reads out the attribution data converted file 80-i from the memory 38 and stores the file 80-i in the second optical disc storage section 44.

The read control section 56 and the video display control section 57 of the control unit 40 in the receiver 3 will next be described. When the user Y reproduces the video data 10-1 to 10-n stored in the optical disc unit 37, the user Y issues a read instruction and a reproduction instruction to the receiver 3 in this order by using the input unit 5.

The read control section 56 reads out the attribution data converted file 80-i from the second optical disc storage section 44 in response to the read instruction, and stores the file 80-i in the memory 38.

The video display control section 57 reads out the storage video data (video data 10-i and outline data 70-i) from the first optical disc storage section 43 in response to the reproduction instruction. The video display control section 57 controls the DEMUX 34 of the receiver 3 to demultiplex the read storage video data into the video data 10-i and the outline data 70-i. The video display control section 57 controls the decoder 35 of the receiver 3 to decode the demultiplexed video data 10-i, and displays the decoded data on the display unit 4. The video display control section 57 recognizes the specific region 9 of the video data 10-i based on the coordinate point A, the coordinate point B, the coordinate point C, the coordinate point D, the instruction “Line” representing the shape of the specific region 9, and the central coordinate point. As shown in FIG. 14, the video display control section 57 displays the demultiplexed outline data 70-i on the display unit 4 while overlaying the outline data 70-i on the specific region 9 of video data 10-i. In this case, the line connecting the coordinate points A and B, the line connecting the coordinate points B and D, the line connecting the coordinate points D and C, the line connecting the coordinate points C and A are displayed on the display unit 4 as one of solid lines, dotted lines, and void lines.

Next, the attribution display control section 58 of the control unit 40 in the receiver will be described. If the user Y wants to know of data on the person 20 and the article 30 appearing in the specific region 9 while the video data 10-i and the outline data 70-i are displayed on the display unit 4, the user Y issues an outline instruction to designate the outline data 70-i by using the input unit 5. The attribution display control section 58 reads out the attribution data converted file 80-i corresponding to the attribution data identifier 72 included in the outline data 70-i from the memory 38 in response to the outline instruction. As shown in FIG. 14, the attribution display control section 58 displays the read attribution data converted file 80-i on the display unit while overlaying the file 80-i on the video data 10-i.

The user Y issues an attribution end instruction to finish displaying the attribution data converted file 80-i by using the input unit 5. The attribution display control section 58 finishes displaying the attribution data converted file 80-i in response to the attribution end instruction.

As described above, according to the digital broadcasting system according to the present invention, the user Y can acquire the attribution data 80-i on the person 20 and article 30 appearing in the specific region 9 of the video data 10-i and requested by the user Y from the video data 10-i of the television broadcast.

The user Y often wants to make contact with the person 20 for the person 20 appearing in the specific region 9 of the video data 10-i. According to the digital broadcasting system of the present invention, since the cover address (the URL of the terminal 7, the telephone number, and the facsimile number) of the person 20 (or the party concerned with the person 20) is displayed as the attribution data converted file 80-i, the user Y can communicate with the person 20 using at least one of the URL of the terminal 7 displayed on the display unit 4, the telephone number, and the facsimile number.

The user Y often wants to make contact with the selling agency for the article 30 appearing in the specific region 9 of the video data 10-i. According to the digital broadcasting system of the present invention, if the cover address (the URL of the terminal 8, the telephone number, and the facsimile number) of the selling agency that sells the article 30 is displayed as the attribution data converted file 80-i, the user Y can communicate with the selling agency using at least one of the URL of the terminal 8 displayed on the display unit 4, the telephone number, and the facsimile number.

The user Y possibly purchases the article 30 by acquiring the data on the article 30 appearing in the specific region 9 of the video data 10-i. The digital broadcasting system of the present invention can promote distribution of the article 30 by allowing the user Y to use the television (receiver 3, display unit 4, and input unit 5).

The URL communication control section 59 of the control unit 40 in the receiver 3 will be described. If the user Y communicates with the person 20 (or the party concerned with the person 20) by using the URL of the terminal 7 displayed on the display unit 4, the user Y issues a URL communication instruction to designate the URL of the terminal 7 included in the attribution data converted file 80-i by using the input unit 5. The URL control communication section 59 controls the communication unit 39 of the receiver 3 to communicate with the terminal 7 through the communication network 6 using the URL of the terminal 7 designated by the URL communication instruction.

If the user Y communicates with the selling agency using the URL of the terminal 8 displayed on the display unit 4, the user Y issues a URL communication instruction to designate the URL of the terminal 8 included in the attribution data converted file 80-i by using the input unit 5. The URL communication control section 59 communicates the communication unit 39 of the receiver 3 to communicate with the terminal 8 through the communication network 6 using the URL of the terminal 8 designated by the URL communication instruction.

The reason for using the optical disc unit 37 and the memory 38 will be described. The digital broadcasting system according to the present invention uses the optical disc unit 37 as the storage unit 36 from the viewpoint of improving the usability of the receiver 3. The optical disc unit 37 has a large storage capacity as the result of a recent development, and is widely spread as a home optical disk, and expected, therefore, as a recording medium in place of a videotape.

The optical disc unit 37 is, however, lower in a read/write operation speed than the hard disk since the optical disc unit 37 reads and writes data by using one head differently from the hard disk. For example, the receiver 3 causes a head to seek the first optical disc storage section 43 of the optical disc unit 37, reads out the storage video data from the first optical disc storage section 43, and displays the video data 10-i and the outline data 70-i on the display unit 4 in response to the reproduction instruction. The user Y issues the outline instruction to designate the outline data 70-i so as to display the attribution data 80-i on the display unit 4. At this time, the receiver needs to cause the head to seek the second optical disc storage section 44 so as to read the attribution data 80-i from the second optical disc storage section 44 of the optical disc unit 37. In this case, the data requested by the user Y (attribution data 80-i) cannot be promptly provided.

In order to promptly provide the data requested by the user Y (attribution data 80-i), the digital broadcasting system according to the present invention uses the memory 38 as the storage unit 36. In the receiver 3, before the video data 10-i is reproduced, the read control section 56 reads out the attribution data 80-i from the second optical disc storage section 44 of the optical disc unit 37 and stores the attribution data 80-i in the memory 38 in response to the read instruction. The video display control section 57 causes the head to seek the first optical disc storage section 43 of the optical disc unit 37, reads the storage video data from the first optical disc storage section 43, and displays the video data 10-i and the outline data 70-i on the display unit 4. To display the attribution data 80-i on the display unit 4, the user Y issues the outline instruction to designate the outline data 70-i. At this time, in the receiver 3, the attribution display control section 58 can read out the attribution data 80-i corresponding to the outline data 70-i from the memory 38 and display the attribution data 80-i on the display unit 4 while the video display control section 57 causes the head to seek the first optical disc storage section 43. Therefore, the digital broadcasting system according to the present invention can provide the data requested by the user (attribution data 80-i) promptly. By using the optical disc unit 37 and the memory 38, the digital broadcasting system according to the present invention can continuously read out the video data 10-1 to 10-n and smoothly reproduce the read video data 10-1 to 10-n.

An operation of the digital broadcasting system according to the present invention will be described. The broadcasting terminal 1 carries out a transmission process for transmitting the transmission data. The receiver 3 carries out a reception process for receiving the transmission data, a video display process for displaying the video data 10-i and the outline data 70-i, and an attribution display process for displaying the attribution data 80-i.

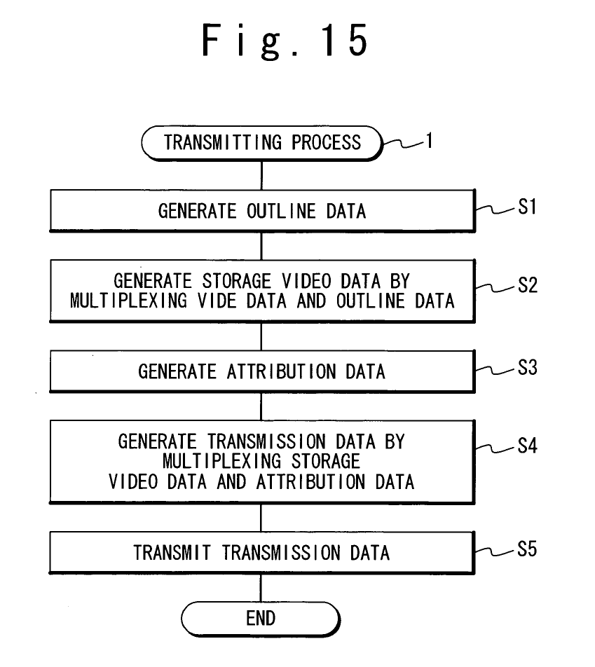

FIG. 15 is a flowchart showing the transmission process as an operation carried out by the broadcasting terminal 1 of the digital broadcasting system according to the present invention. It is assumed herein that the person 20 is an actor and the person (actor) 20 wears a suit as the article 30. The selling agency (user W) notifies the broadcasting station X of the name of the article 30, the price of the article 30, the name of the selling agency that sells the article 30, and the cover address (URL of the terminal 8, telephone number, and facsimile number) of the selling agency to sell the article 30 (suit).

The outline generating section 21 takes out the video data 10-i from the video data 10-1 to 10-n stored in the storage unit 14 through an operation of the input unit by the operator of the broadcasting station X. The taken-out video data 10-i is displayed on the display unit of the broadcasting terminal 1. The operator of the broadcasting station X determines the specific region 9 in which the person (actor) 20 and the article (suit) 30 appear while referring to the video data 10-i. The outline data generating section 21 generates the outline data 70-i representing the specific region 9 of the video data 10-i by the operator of the broadcasting station X. Namely, the outline data generating section 21 writes, as the position data 71, the coordinate point A, the coordinate point B, the coordinate point C, the coordinate point D, the instruction “Line” representing the shape of the specific region 9, and the central coordinate point in the position data field of the outline data 70-i through the operation of the input unit by the operator of the broadcasting station X. The outline data generating section 21 writes the attribution data identifier 72 in the attribution data identifier field of the outline data 70-i by the operator of the broadcasting station X (at S1).

The storage video data generating section 22 controls the MUX 11 to multiplex the video data 10-i with the outline data 70-i and generates the storage video data by the operator of the broadcasting station X (at S2).

The attribution data generating section 23 generates the attribution data 80-i through an operation of the input unit by the operator of the broadcasting station X. Namely, the attribution data generating section 23 writes, as the personal data 81, the name, the age, and the record of performance of the person (actor) 20 in the personal data field of the attribution data 80-i by the operator of the broadcasting station X. The attribution data generating section 23 writes the name and the price of the article (suit) 30, the name of the selling agency, and the cover address (URL of the terminal 8, telephone number, and facsimile number) of the selling agency which are notified by the selling agency (user W) in the article data field of the attribution data 80-i by the operator of the broadcasting station X. The attribution data generating section 23 writes the attribution data identifier 83 corresponding to the attribution data identifier 72 in the attribution data identifier field of the attribution data 80-i by the operator of the broadcasting station X (at S3).

The transmission data generating section 24 controls the MUX 12 to multiply the storage video data (video data 10-i and outline data 70-i) with the attribution data 80-i, and generates the transmission data by the operation by the operator of the broadcasting station X (at S4).

The transmission control section 25 stores the transmission data {storage video data (video data 10-i and outline data 70-i) and attribution data 80-i} generated by the transmission data generating section 24 in the storage unit 14. The transmission control section 25 controls the transmitting unit 13 to transmit the first to the n-th transmission data stored in the storage unit 14 to the receiver 3 in this order (at S5).

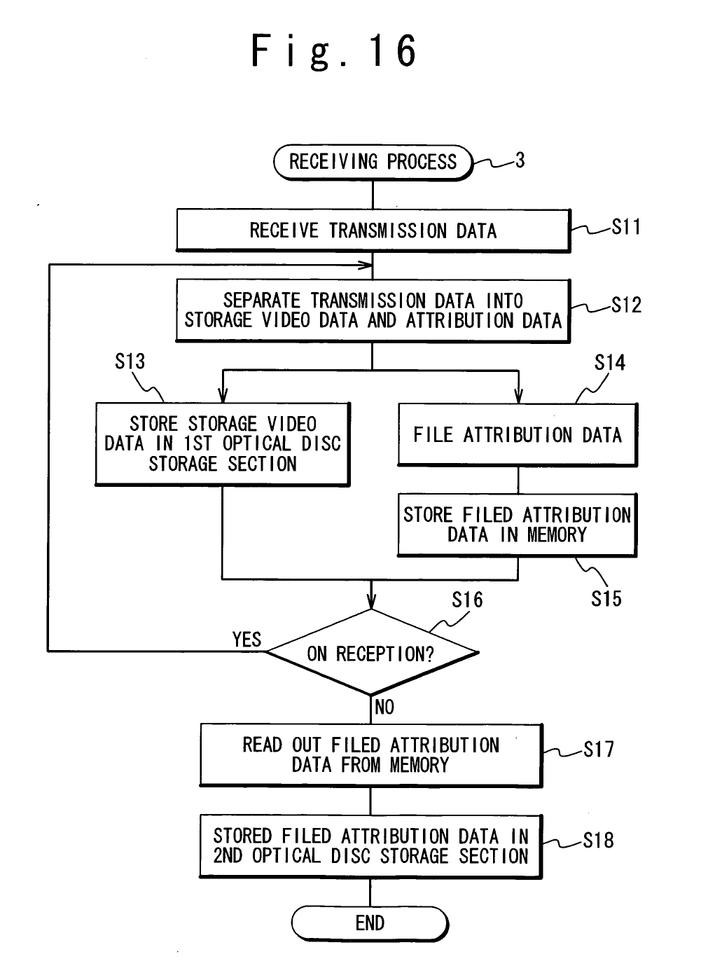

FIG. 16 is a flowchart showing the reception process as the operation performed by the receiver 3 of the digital broadcasting system according to the present invention.

The receiving unit 31 receives the transmission data from the broadcasting terminal 1. When the receiving unit 31 receives the transmission data, the reception control section 51 outputs the reception detection signal to the flag storage section 55. The attribution storage permission instruction flag 60 is reset by the flag storage section 55 in response to the reception detection signal (at S11).

The video storage control section 52 controls the DEMUX 32 to demultiplex the transmission data received by the receiving unit 31 into the storage video data (video data 10-i and outline data 70-i) and the attribution data 80-i (at S12).

The video storage control section 52 controls the decoder 33 to decode the storage video data (video data 10-i and outline data 70-i) demultiplexed by the DEMUX 32, and stores the decoded data in the optical disc storage section 43 (at S13).

At the same time, the first attribution storage control section 53 converts the attribution data 80-i demultiplexed by the video storage control section 52 into a file (in the form suited for the read operation of the data 80-i by the attribution display control section 58 and suited for display of the data 80-i on the display unit 4), and generates the attribution data converted file 80-i (at S14). The first attribution storage control section 53 stores the generated attribution data converted file 80-i in the memory 38 (at S15).

The receiving unit 31 receives next transmission data from the broadcasting terminal 1 (“YES” at S16). In this case, the receiver 3 (video storage control section 52 and first attribution storage control section 53) carries out the steps S12 to S15. The video storage control section 52 stores (records) the storage video data (video data 10-i and the outline data 70-i) in the first optical disc storage section 43. For this reason, the attribution storage permission instruction flag 60 is not set by the flag storage section 55.

The receiving unit 31 does not receive the next transmission data from the broadcasting terminal 1 (“NO” at S16). Namely, the receiver 3 has already received the first to the n-th transmission data from the broadcasting terminal 1. In this case, the reception control section 51 outputs the reception non-detection signal to the flag storage section 55 in place of the reception detection signal. The attribution storage permission instruction flag is set by the flag storage section 55 in response to the reception non-detection signal.

If the attribution storage permission instruction flag 60 is set in the flag storage section 55, the second attribution storage control section 54 reads out the attribution data converted file 80-i from the memory 38 (at S17). The second attribution storage control section 54 stores the read attribution data converted file 80-i in the second optical disc storage section 44 (at S18).

In the digital broadcasting system according to the present invention, when the receiver 3 receives transmission data, the video storage control section 52 first stores the storage video data (video data 10-i and outline data 70-i) in the first optical disc storage section 43 and the second attribution storage control section 54 then stores the attribution data 80-i in the second optical disc storage section 44. Therefore, the receiver 3 can continuously read the video data 10-1 to 10-n and smoothly reproduce the read video data 10-1 to 10-n by using the video display process to be described later.

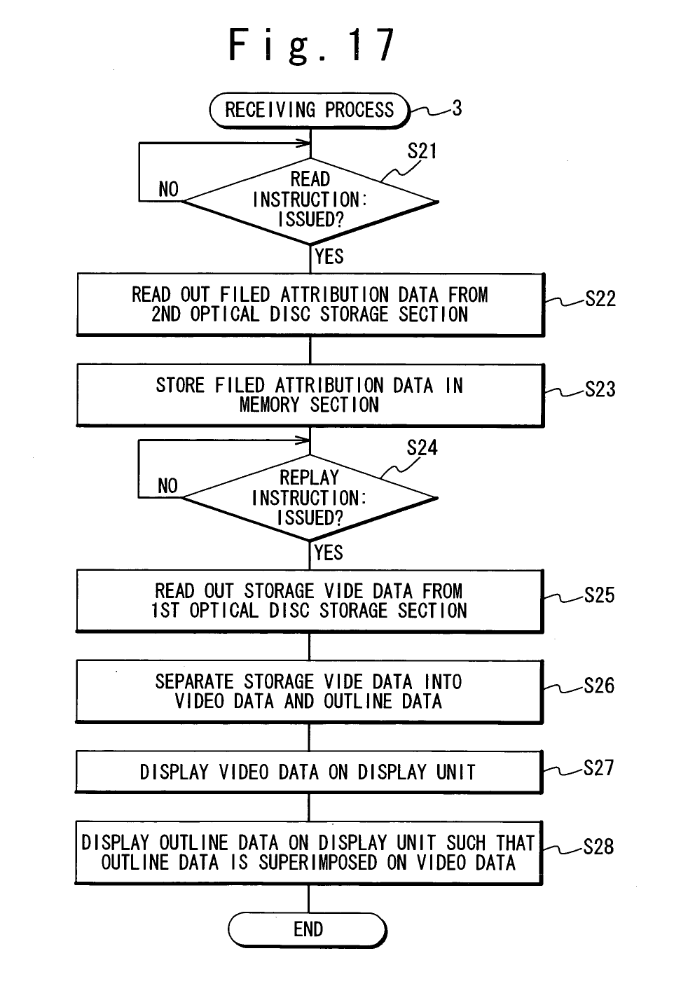

FIG. 17 is a flowchart showing the video display process as an operation performed by the receiver 3 of the digital broadcasting system according to the present invention.

The user Y issues the read instruction to the receiver 3 by using the input unit 5 (“YES” at S21). At this time, the read control section 56 reads out the attribution data converted file 80-i from the second optical disc storage section 44 in response to the read instruction (at S22), and stores the file 80-i in the memory 38 (at S23).

The user Y issues the reproduction instruction to the receiver 3 by using the input unit 5 (“YES” at S24). At this time, the video display control section 57 reads out the storage video data (video data 10-i and the outline data 70-i) from the first optical disc storage section 43 in response to the reproduction instruction (at S25). The video display control section 57 controls the DEMUX 34 to demultiplex the read storage video data into the video data 10-i and the outline data 70-I (at S26).

The video display control section 57 controls the decoder 35 to decode the demultiplexed video data 10-i, and displays the decoded data on the display unit 4 (at S27).

The video display control section 57 recognizes the specific region 9 of the video data 10-i based on the coordinate point A, the coordinate point B, the coordinate point C, the coordinate point D, the instruction “Line” representing the shape of the specific region 9, and the central coordinate point included in the position data 71 on the demultiplexed outline data 70-i. The video display control section 57 displays, as the demultiplexed outline data 70-i, the line connecting the coordinate points A and B, the line connecting the coordinate points B and D, the line connecting the coordinate points D and C, the line connecting the coordinate points C and A on the display unit 4 while overlaying the outline data 70-i on the specific region 9 of video data 10-i (at S28).

In the digital broadcasting system according to the present invention, the receiver 3 always causes the head to seek the first optical disc storage section 43. The video data 10-1 to 10-n can be continuously read out, and the read video data 10-1 to 10-n can be smoothly reproduced.

Further, in the digital broadcasting system according to the present invention, the receiver 3 recognizes the specific region 9 of the video data 10-i. Therefore, it is preferable that the outline data 70-i includes the position data 71 (the coordinate point A, the coordinate point B, the coordinate point C, the coordinate point D, the instruction “Line” representing the shape of the specific region 9, and the central coordinate point).

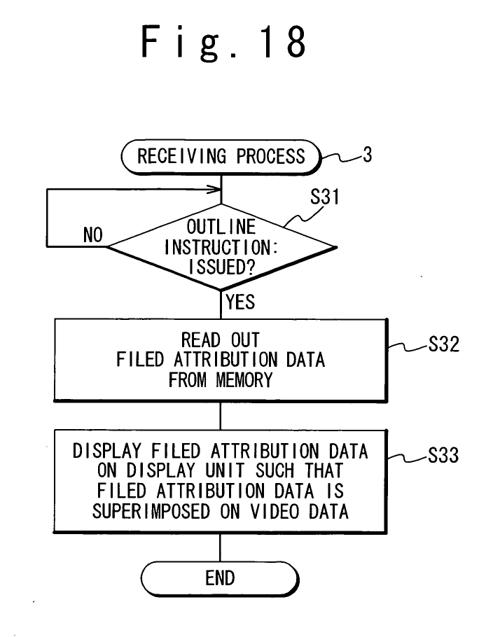

FIG. 18 is a flowchart showing the attribution display process as an operation of the receiver 3 of the digital broadcasting system according to the present invention. The attribution display process is carried out only when the video display process is carried out.

If the user Y wants to know of data on the person 20 and the article 30 appearing in the specific region 9 of the video data 10-i of the television broadcast, the user Y issues the outline instruction to designate the outline data 70-i by using the input unit 5 (“YES” at 31). The attribution display control section 58 reads out the attribution data converted file 80-i corresponding to the attribution data identifier 72 included in the outline data 70-i from the memory 38 in response to the outline instruction (at S32). The attribution display control section 58 displays the read attribution data converted file 80-i on the display unit while overlaying the file 80-i on the video data 10-i. At this time, the name, the age, and the record of performance of the person (actor) 20 are displayed as the personal data 81 on the attribution data converted file 80-i, and the name and the price of the article (suit) 30, the name and the cover address (URL of the terminal 8, telephone number, and facsimile number) of the selling agency (user W) are displayed as the article data 82 on the attribution data converted file 80-i on the display unit 4 (at S33).

In the digital broadcasting system according to the present invention, the receiver 3 provides the user Y with the attribution data 80-i on the specific region 9 of the video data 10-i in response to the request of the user Y (outline instruction). If the user Y wants to know of the data on the person 20 and the article 30 appearing in the specific region 9 of the video data 10-i of the television broadcast, the user Y can acquire the attribution data 80-i as the data on the person 20 and article 30 requested by the user from the video data 10-i of the television broadcast. Therefore, the digital broadcasting system according to the present invention can ensure improved usability of the receiver 3 by allowing the user Y not only to view the television broadcast (video data) but to issue a request when the user Y wants to know of the data (attribution data).

Furthermore, as described above, the digital broadcasting system according to the present invention uses the optical disc unit 37 as the storage unit 36 so as to improve the usability of the receiver 3. The digital broadcasting system according to the present invention further uses the memory 38 as the storage unit 36. The receiver 3 reads the attribution data 80-i corresponding to the outline data 70-i and displays the attribution data 80-i on the display unit 4 while causing the head to seek the first optical disc storage section 43. Therefore, the digital broadcasting system according to the present invention can provide the attribution data 80-i requested by the user promptly.

Moreover, in the digital broadcasting system according to the present invention, it is preferable that the attribution data identifier 72 is included in the outline data 70-i and the attribution data identifier 83 corresponding to the attribution data identifier 72 is included in the attribution data 80-i so that the receiver 3 can read out the attribution data 80-i corresponding to the outline data 70-i from the memory 38.

At the step S33, the user Y often wants to know of more data on the article (suit) 30 after viewing the article (suit) 30 displayed on the display unit 4. The user Y often wants to place an order for the article (suit) 30 after viewing the article (suit) 30 displayed on the display unit 4. In addition, the user Y often takes a fancy to the article (suit) 30 which the person (actor) 20 wears and wants to place an order for the article (suit) 30 after viewing the person (actor) 20 displayed on the display unit 4.

If such a request is issued, the user Y communicates with the selling agency (user W) using at least one of the URL, the telephone number, and the facsimile number displayed on the display unit 4. If the user Y designates the URL (issues the URL communication instruction) by using the input unit 5, the URL communication control section 59 controls the communication unit 39 to communicate with the terminal 8 through the communication network 6 using the URL designated by the URL communication instruction.

As can be seen, the digital broadcasting system according to the present invention can satisfy the request of the user Y.

Further, the digital broadcasting system according to the present invention can promote distribution if the user views the article (suit) 30 appearing in the specific region of the video data 10-i and places an order for the article (suit) 30. The digital broadcasting system according to the present invention preferably provides the user Y with the data on the article (suit) 30 which the person (actor) 30 wears so as to promote distribution of the article (suit) 30.

1. A digital broadcasting system comprising:
a broadcasting terminal connected with a network, and configured to broadcast transmission data which contains video data for television broadcasting, outline data indicating a specific area of said video data and attribution data relating to said specific area; and
a receiver connected with said network and having a display unit,
said receiver comprises:
a storage unit; and
a control unit configured to receive said transmission data from said broadcasting terminal, and to store said video data, said outline data and said attribution data of said transmission data in said storage unit, and
said control unit comprises:
a video display control section configured to display said video data and said outline data stored in said storage unit on said display unit in response to a reproduction instruction from a user; and
an attribution display control section configured to read out said attribution data corresponding to said outline data from said storage unit in response to an outline instruction from the user, and to display said attribution data on said display unit such that said attribution data is overlaid on said video data.

2. The digital broadcasting system according to claim 1, wherein said storage unit comprises:
a first optical disc storage section as a first memory region, a second optical disc storage section as a second memory region, and a memory,
said first optical disc storage section stores said video data and said outline data, and
said second optical disc storage section stores said attribution data,
said control unit further comprises:
a read control section configured to read out said attribution data from said second optical disc storage section in response to a read instruction from the user to store in said memory,
said video display control section displays said video data and said outline data stored in said first optical disc storage section on said display unit in response to said reproduction instruction after said read instruction, and
said attribution display control section reads said attribution data corresponding to said outline data from said memory in response to said outline instruction, and displays said attribution on said display unit such that said attribution data is overlaid on said video data.

3. The digital broadcasting system according to claim 2, wherein said control unit further comprises:
a video storage control section configured to store said video data and said outline data in said first optical disc storage section when receiving said transmission data from said broadcasting terminal;
a first attribution storage control section configured to store said attribution data in said memory when receiving said transmission data from said broadcasting terminal;
a reception control section configured to output an attribution storage permission instruction when not receiving said transmission data from said broadcasting terminal; and
a second attribution storage control section configured to read out said attribution data from said memory in response to said attribution storage permission instruction to store in said second optical disc storage section.

4. The digital broadcasting system according to claim 2, wherein said outline data contains an attribution data identifier to identify said attribution data, and
said attribution display control section reads out said attribution data corresponding to said attribution data identifier from said memory in response to said outline instruction and displays on said display unit such that said attribution data is overlaid on said video data.

5. The digital broadcasting system according to claim 1, wherein said outline data contains position data to specify a position of said specific area of said video data, and
said video display control section reads out said video data and said outline data stored in said storage unit in response to said reproduction instruction, displays said video data on said display unit, and displays said outline data in said specific area of said video data on said display unit based on said position data such that said outline data is overlaid on said video data.

6. A receiver for receiving transmission data which contains video data for television broadcasting, outline data indicating a specific area of said video data and attribution data relating to said specific area, comprising:
a storage unit; and
a control unit configured to receive said transmission data, and to store said video data, said outline data and said attribution data of said transmission data in said storage unit, and
said control unit comprises:
a video display control section configured to display said video data and said outline data stored in said storage unit on said display unit in response to a reproduction instruction from a user; and
an attribution display control section configured to read out said attribution data corresponding to said outline data from said storage unit in response to an outline instruction from the user, and to display said attribution data on said display unit such that said attribution data is overlaid on said video data.

7. The receiver according to claim 6, wherein said storage unit comprises:
a first optical disc storage section as a first memory region, a second optical disc storage section as a second memory region, and a memory,
said first optical disc storage section stores said video data and said outline data, and
said second optical disc storage section stores said attribution data,
said control unit further comprises:
a read control section configured to read out said attribution data from said second optical disc storage section in response to a read instruction from the user to store in said memory,
said video display control section displays said video data and said outline data stored in said first optical disc storage section on said display unit in response to said reproduction instruction after said read instruction, and
said attribution display control section reads said attribution data corresponding to said outline data from said memory in response to said outline instruction, and displays said attribution on said display unit such that said attribution data is overlaid on said video data.

8. The receiver according to claim 7, wherein said control unit further comprises:
a video storage control section configured to store said video data and said outline data in said first optical disc storage section when receiving said transmission data from said broadcasting terminal;
a first attribution storage control section configured to store said attribution data in said memory when receiving said transmission data from said broadcasting terminal;
a reception control section configured to output an attribution storage permission instruction when not receiving said transmission data from said broadcasting terminal; and
a second attribution storage control section configured to read out said attribution data from said memory in response to said attribution storage permission instruction to store in said second optical disc storage section.

9. The receiver according to claim 7, wherein said outline data contains an attribution data identifier to identify said attribution data, and
said attribution display control section reads out said attribution data corresponding to said attribution data identifier from said memory in response to said outline instruction and displays on said display unit such that said attribution data is overlaid on said video data.

10. The receiver according to claim 6, wherein said outline data contains position data to specify a position of said specific area of said video data, and
said video display control section reads out said video data and said outline data stored in said storage unit in response to said reproduction instruction, displays said video data on said display unit, and displays said outline data in said specific area of said video data on said display unit based on said position data such that said outline data is overlaid on said video data.

11. The receiver according to claim 6, wherein said attribution data contains at least one of personal data relating to a person in said specific area of said video data and article data relating to an article in said specific area of said video data.

12. The receiver according to claim 11, wherein said attribution data contains at least an URL of an attribution relating terminal relating to the person or a selling agency of the article.

13. The receiver according to claim 12, wherein said receiver is connected with a communication network, and
said control unit further comprises:
an URL communication control section configured to communicate with said attribution relating terminal through the communication network by using said URL in response to an URL communication instruction from the user.

14. A computer-readable software product for realizing a method of allowing data relating to television broadcast to be utilized, said method comprising:
receiving transmission data which contains video data for the television broadcast, outline data indicating a specific area of said video data and attribution data relating to said specific area;
storing said video data, said outline data and said attribution data contained in said transmission data in a storage unit;
reading out said video data and said outline data from said storage unit in response to a reproduction instruction from a user to display on said display unit; and
reading out said attribution data corresponding to said outline data from said storage unit in response to an outline instruction from the user, to display said attribution data on said display unit such that said attribution data is overlaid on said video data.

15. The software product according to claim 14, wherein said storing comprises:
storing said video data and said outline data in a first optical disc storage section of said storage unit; and
storing said attribution data in a second optical disc storage section of said storage unit,
said reading out said video data and said outline data comprises:
reading out said video data and said outline data from said first optical disc storage section to display on said display unit in response to said reproduction instruction, and
said reading out said attribution data comprises:
reading out said attribution data from said second optical disc storage section in response to a read instruction from the user before said reproduction instruction to store in a memory of said storage unit,
reading out said attribution data from said memory in response to said outline instruction, to display said attribution on said display unit such that said attribution data is overlaid on said video data.

16. The software product according to claim 15, wherein said storing said attribution data comprises:
storing said attribution data in said memory when receiving said transmission data;
setting an attribution storage permission flag when not receiving said transmission data; and
reading out said attribution data from said memory in response to said attribution storage permission flag to store in said second optical disc storage section.

17. The software product according to claim 15, wherein said outline data contains an attribution data identifier to identify said attribution data, and
said reading out said attribution data comprises:
reading out said attribution data corresponding to said attribution data identifier from said memory in response to said outline instruction to display on said display unit such that said attribution data is overlaid on said video data.

18. The software product according to claim 14, wherein said outline data contains position data to specify a position of said specific area of said video data, and
said reading out said video data and said outline data comprises:
reading out said video data and said outline data from said storage unit in response to said reproduction instruction, to display said video data on said display unit, and to display said outline data in said specific area of said video data on said display unit based on said position data such that said outline data is overlaid on said video data.

19. The software product according to claim 14, wherein said attribution data contains at least one of personal data relating to a person in said specific area of said video data and article data relating to an article in said specific area of said video data.

20. The software product according to claim 19, wherein said attribution data contains at least an URL of an attribution relating terminal relating to the person or a selling agency of the article.

21. The software product according to claim 20, wherein said method further comprises:
communicating with an attribution relating terminal relating to the person or selling agency through a communication network by using said URL in response to an URL communication instruction from the user.

22. A method of allowing data relating to television broadcast to be utilized, comprising:
broadcasting through a network, transmission data which contains video data for television broadcasting, outline data indicating a specific area of said video data and attribution data relating to said specific area;
receiving said transmission data;
storing said video data, said outline data and said attribution data contained in said transmission data in a storage unit;
reading out said video data and said outline data from said storage unit in response to a reproduction instruction from a user to display on said display unit; and
reading out said attribution data corresponding to said outline data from said storage unit in response to an outline instruction from the user, to display said attribution data on said display unit such that said attribution data is overlaid on said video data.

23. The method according to claim 22, wherein said storing comprises:
storing said video data and said outline data in a first optical disc storage section of said storage unit; and
storing said attribution data in a second optical disc storage section of said storage unit,
said reading out said video data and said outline data comprises:
reading out said video data and said outline data from said first optical disc storage section to display on said display unit in response to said reproduction instruction, and
said reading out said attribution data comprises:
reading out said attribution data from said second optical disc storage section in response to a read instruction from the user before said reproduction instruction to store in a memory of said storage unit,
reading out said attribution data from said memory in response to said outline instruction, to display said attribution on said display unit such that said attribution data is overlaid on said video data.

24. The method according to claim 23, wherein said storing said attribution data comprises:
storing said attribution data in said memory when receiving said transmission data;
setting an attribution storage permission flag when not receiving said transmission data; and
reading out said attribution data from said memory in response to said attribution storage permission flag to store in said second optical disc storage section.

25. The method according to claim 23, wherein said outline data contains an attribution data identifier to identify said attribution data, and
said reading out said attribution data comprises:
reading out said attribution data corresponding to said attribution data identifier from said memory in response to said outline instruction to display on said display unit such that said attribution data is overlaid on said video data.

26. The method according to claim 22, wherein said outline data contains position data to specify a position of said specific area of said video data, and
said reading out said video data and said outline data comprises:
reading out said video data and said outline data from said storage unit in response to said reproduction instruction, to display said video data on said display unit, and to display said outline data in said specific area of said video data on said display unit based on said position data such that said outline data is overlaid on said video data.

27. The method according to claim 22, wherein said attribution data contains at least one of personal data relating to a person in said specific area of said video data and article data relating to an article in said specific area of said video data.

28. The method according to claim 27, wherein said attribution data contains at least an URL of an attribution relating terminal relating to the person or a selling agency of the article.

29. The method according to claim 28, wherein further comprising:
communicating with an attribution relating terminal relating to the person or selling agency through a communication network by using said URL in response to an URL communication instruction from the user.
